(19) United States
(12) Patent Application Publication
(10) Pub. No.: US 2024/0423136 A1
(43) Pub. Date: Dec. 26, 2024

(54) CONVEYING SYSTEM FOR AN AGRICULTURAL HARVESTER

(71) Applicant: CNH Industrial America LLC, New Holland, PA (US)

(72) Inventors: Niels Dybro, Muscatine, IA (US); Jason D. Wattonville, Alleman, IA (US); Scott Simmons, Lititz, PA (US)

(21) Appl. No.: 18/747,746

(22) Filed: Jun. 19, 2024

Related U.S. Application Data
(60) Provisional application No. 63/521,993, filed on Jun. 20, 2023.
(60) Provisional application No. 63/515,415, filed on Jul. 25, 2023.
(60) Provisional application No. 63/534,226, filed on Aug. 23, 2023.

(51) Int. Cl. A01F 15/07; A01F 15/18

(52) U.S. Cl. CPC A01F 15/071; A01F 15/18

(57) ABSTRACT

A conveying system for an agricultural harvester includes a leveling drum assembly configured to be positioned upstream of a belt configured to move agricultural product from an accumulator to a bale formation cavity of a baler. The leveling drum assembly is configured to rotate in an opposite direction relative to a direction of rotation of the belt, and the leveling drum assembly is configured to level a surface of the agricultural product before the surface of the agricultural product engages the belt. The leveling drum assembly includes a drum configured to rotate about a first axis of rotation. The leveling drum assembly includes a shaft disposed within the drum and configured to rotate about a second axis of rotation offset from the first axis of rotation. The leveling drum assembly also includes multiple tines pivotally coupled to the shaft and configured to extend through respective apertures in the drum.

### CROSS-REFERENCE TO RELATED APPLICATIONS

This application claims priority from and the benefit of U.S. Provisional Application Ser. No. 63/521,993, entitled “BALING SYSTEM FOR AN AGRICULTURAL SYSTEM”, filed Jun. 20, 2023, U.S. Provisional Application Ser. No. 63/515,415, entitled “CONVEYING SYSTEM FOR AN AGRICULTURAL HARVESTER”, filed Jul. 25, 2023, and U.S. Provisional Application Ser. No. 63/534,226, entitled “BALING SYSTEM FOR AN AGRICULTURAL SYSTEM”, filed Aug. 23, 2023. Each of the foregoing applications is hereby incorporated by reference in its entirety.

### BACKGROUND

The present disclosure relates generally to a conveying system for an agricultural harvester.

Agricultural harvesters are used to harvest agricultural products (e.g., cotton or other natural material(s)). For example, an agricultural harvester may include a header having drums configured to harvest the agricultural product from a field. The agricultural harvester may also include an air-assisted conveying system configured to move the agricultural product from the drums to an accumulator. The agricultural product may then be fed into a baler via a conveying system. The baler may compress the agricultural product into a package to facilitate storage, transport, and handling of the agricultural product. For example, a round baler may compress the agricultural product into a round bale within a baling chamber, such that the round bale has a desired size and density. After forming the bale, the bale may be wrapped with a bale wrap to secure the agricultural product within the bale and to generally maintain the shape of the bale.

### BRIEF DESCRIPTION

In certain embodiments, a conveying system for an agricultural harvester includes a leveling drum assembly configured to be positioned upstream of a belt configured to move agricultural product from an accumulator to a bale formation cavity of a baler. The leveling drum assembly is configured to rotate in an opposite direction relative to a direction of rotation of the belt, and the leveling drum assembly is configured to level a surface of the agricultural product before the surface of the agricultural product engages the belt. The leveling drum assembly includes a drum configured to rotate about a first axis of rotation. Furthermore, the leveling drum assembly includes a shaft disposed within the drum and configured to rotate about a second axis of rotation offset from the first axis of rotation. The leveling drum assembly also includes multiple tines pivotally coupled to the shaft and configured to extend through respective apertures in the drum.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of an agricultural machine system having an agricultural product transport assembly;

FIG. 2 is a schematic view of an embodiment of an agricultural product transport assembly that may be employed within the agricultural machine system of FIG. 1;

FIG. 3 is a schematic view of an embodiment of a conveying system that may be employed within the agricultural product transport assembly of FIG. 2;

FIG. 4 is a cross-sectional view of an embodiment of a leveling drum assembly that may be employed within the conveying system of FIG. 3;

FIG. 5A is a perspective view of an embodiment of a drum that may be employed within the leveling drum assembly of FIG. 4;

FIG. 5B is a projection view of an outer surface of the drum of FIG. 5A;

FIG. 6A is a perspective view of another embodiment of a drum that may be employed within the leveling drum assembly of FIG. 4;

FIG. 6B is a projection view of an outer surface of the drum of FIG. 6A;

FIG. 7A is a perspective view of a further embodiment of a drum that may be employed within the leveling drum assembly of FIG. 4; and

FIG. 7B is a projection view of an outer surface of the drum of FIG. 7A.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

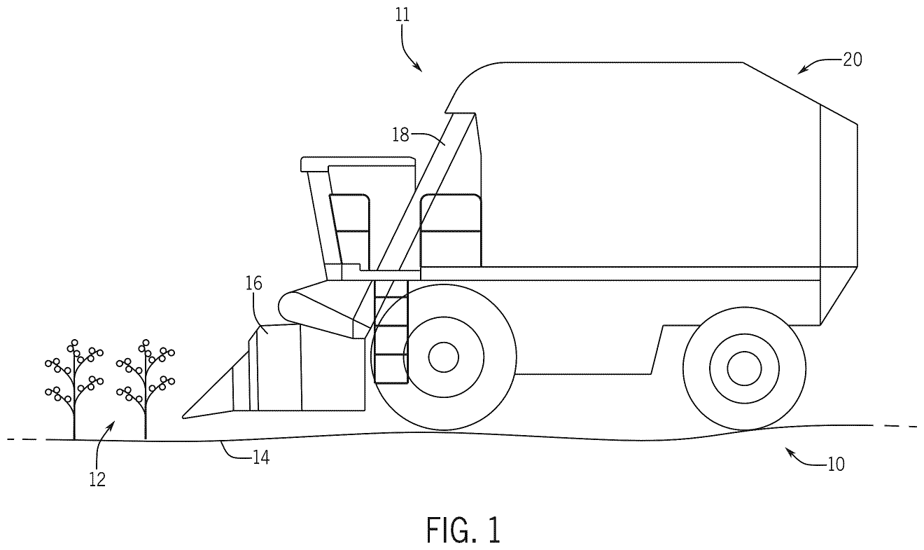

FIG. 1 is a side view of an embodiment of an agricultural machine system 10 (e.g., harvester, agricultural harvester) having an agricultural product transport assembly 11. The agricultural machine system 10 is configured to harvest agricultural product 12 (e.g., cotton) from a field 14 and to form the agricultural product 12 into bales (e.g., agricultural bales). In the illustrated embodiment, the agricultural machine system 10 includes a header 16 having drums configured to harvest the agricultural product 12 from the field 14. Additionally, the agricultural product transport assembly 11 of the agricultural machine system 10 includes an air-assisted conveying system 18 configured to move the agricultural product 12 from the drums of the header 16 to an accumulator of the agricultural product transport assembly 11. The agricultural product transport assembly 11 also includes a conveying system configured to convey the agricultural product 12 from the accumulator into a cavity (e.g., bale formation cavity) of a baler 20 (e.g., agricultural baler). The baler 20 is supported by and/or mounted within or on a chassis of the agricultural machine system 10. The baler 20 may form the agricultural product 12 into round bales. However, in other embodiments, the baler 20 of the agricultural machine system 10 may form the agricultural product into square bales, polygonal bales, or bales of other suitable shape(s). After forming the agricultural product 12 into a bale, a bale wrapping system of the agricultural machine system 10 wraps the bale with a bale wrap to secure the agricultural product 12 within the bale and to generally maintain a shape of the bale.

As discussed in detail below, the conveying system includes a first belt (e.g., belt) configured to move the agricultural product 12 from the accumulator to the cavity (e.g., bale formation cavity) of the baler 20. The first belt is configured to rotate in a first rotational direction to move an agricultural product engaging surface of the first belt toward the bale formation cavity. In certain embodiments, the conveying system includes a second belt configured to be positioned on an opposite side of the agricultural product 12 from the first belt, and the second belt is configured to cooperate with the first belt to move the agricultural product from the accumulator to the bale formation cavity. Furthermore, the conveying system includes a leveling drum assembly positioned upstream of the first belt. The leveling drum assembly is configured to rotate in a second rotational direction, opposite the first rotational direction, and the leveling drum assembly is configured to level a surface of the agricultural product before the surface of the agricultural product engages the agricultural product engaging surface of the first belt. In certain embodiments, the leveling drum assembly includes a drum configured to rotate about a first axis of rotation, and the leveling drum assembly includes a shaft disposed within the drum and configured to rotate about a second axis of rotation offset from the first axis of rotation. The leveling drum assembly also includes tines pivotally coupled to the shaft and configured to extend through respective apertures in the drum. The tines are configured to engage the agricultural product, and the combination of the drum and the tines is configured to level the surface of the agricultural product, thereby enhancing the uniformity of the distribution of the agricultural product entering the bale formation cavity. As a result, density variations within the resultant bale may be reduced, thereby enhancing downstream processing of the agricultural product.

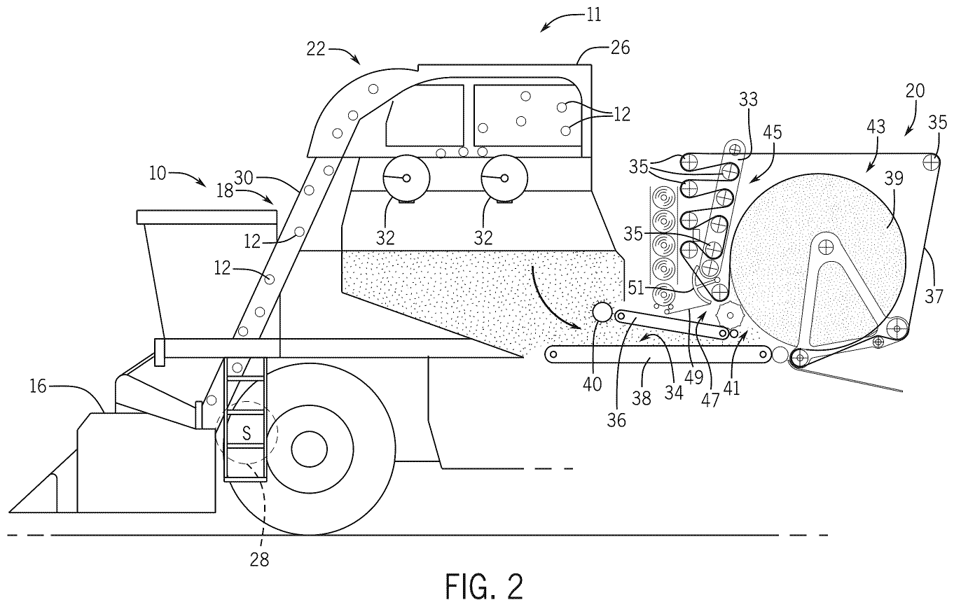

FIG. 2 is a schematic view of an embodiment of an agricultural product transport assembly 11 that may be employed within the agricultural machine system of FIG. 1. As previously discussed, the header 16 of the agricultural machine system 10 includes drums configured to harvest the agricultural product 12 (e.g., cotton) from the field. Furthermore, the air-assisted conveying system 18 is configured to move the agricultural product 12 from the drums of the header 16 to the accumulator 26. In the illustrated embodiment, the air-assisted conveying system 18 includes a conveying air source 28 configured to output a conveying air flow through one or more ducts 30. Each duct 30 receives the agricultural product 12 (e.g., cotton) from the header 16, and the conveying air flow output by the conveying air source 28 drives the agricultural product to move through the duct(s) 30 from the header 16 to the accumulator 26. In the illustrated embodiment, the agricultural product transport assembly 11 includes augers 32 configured to distribute the agricultural product 12 (e.g., cotton) laterally across the accumulator 26 (e.g., crosswise to the downward movement of the agricultural product through the accumulator). In the illustrated embodiment, the agricultural product transport assembly 11 includes two augers 32. However, in other embodiments, the agricultural product transport assembly may include more or fewer augers (e.g., 0, 1, 3, 4, or more).

In the illustrated embodiment, the conveying system 34 of the agricultural product transport system 11 includes a first belt (e.g., belt) 36 configured to move the agricultural product 12 from the accumulator 26 to the cavity 41 (e.g., bale formation cavity) of the baler 20. The first belt 36 is configured to rotate in a first rotational direction to move an agricultural product engaging surface of the first belt 36 toward the cavity 41. Furthermore, in the illustrated embodiment, the conveying system 34 includes a second belt 38 positioned on an opposite side of the agricultural product 12 from the first belt 36, and the second belt 38 is configured to cooperate with the first belt 36 to move the agricultural product 12 from the accumulator 26 to the cavity 41. Furthermore, the conveying system 34 includes a leveling drum assembly 40 positioned upstream of the first belt 36. The leveling drum assembly 40 is configured to rotate in a second rotational direction, opposite the first rotational direction, and the leveling drum assembly 40 is configured to level a surface of the agricultural product 12 before the surface of the agricultural product 12 engages the agricultural product engaging surface of the first belt 36. In certain embodiments, the leveling drum assembly 40 includes a drum configured to rotate about a first axis of rotation, and the leveling drum assembly includes a shaft disposed within the drum and configured to rotate about a second axis of rotation offset from the first axis of rotation. The leveling drum assembly 40 also includes tines pivotally coupled to the shaft and configured to extend through respective apertures in the drum. The tines are configured to engage the agricultural product, and the combination of the drum and the tines is configured to level the surface of the agricultural product, thereby enhancing the uniformity of the distribution of the agricultural product entering the cavity 41. As a result, density variations within the resultant bale may be reduced, thereby enhancing downstream processing of the agricultural product.

In the illustrated embodiment, the baler 20 includes multiple rollers 35 that support and/or drive rotation of one or more belts 37. For example, one or more rollers 35 engage the belt(s) 37, which enable the belt(s) 37 to move along the pathway defined by the rollers 37 and the bale 39. One or more rollers 35 are driven to rotate via a belt drive system (e.g., including electric motor(s), hydraulic motor(s), pneumatic motor(s), etc.). The belt(s) 37 circulate around the pathway defined by the rollers 35 and the bale 39. Movement of the belt(s) 37 captures agricultural product 12 from the conveying system 34 and draws the agricultural product 12 into the cavity 41 (e.g., bale formation cavity), where the agricultural product 12 is gradually built up to form the bale 39.

In the illustrated embodiment, the baler 20 includes a tension arm 33 configured to establish tension within the belt(s) 37. As the agricultural product 12 builds within the cavity 41, the agricultural product 12 applies a force to the belt(s) 37 that urges a first portion 43 of the belt(s) 37 surrounding the bale 39 to expand. Concurrently, the size of a second portion 45 (e.g., serpentine portion) of the belt(s) 37 is reduced. Accordingly, the second portion 45 of the belt(s) 37 provides the increasing belt length for the expanding first portion 43. In the illustrated embodiment, the second portion 45 of the belt(s) 37 is established by fixed rollers 35 (e.g., rollers fixed to a housing/frame of the baler 20) and rollers 35 coupled to the tension arm 33, which is pivotable relative to the fixed rollers 35 (e.g., relative to the housing/frame of the baler 20). Accordingly, as the agricultural product 12 builds within the cavity 41, the tension arm 33 is driven to rotate, thereby reducing the size of the second portion 45 and enabling the first portion 43 to expand.

Once the bale 39 reaches a desired size, a bale wrapping system 47 of the baler 20 wraps the bale 39 with a bale wrap 49 to secure the agricultural product within the bale 39 and to generally maintain a shape of the bale 39, such as the round shape in the illustrated embodiment. In other embodiments, the shape of the bale may be rectangular, polygonal, or another suitable shape. The bale wrap 49 may be fed into contact with the bale 39 using one or more feed rollers. The feed rollers drive the bale wrap 49 over a wrap guide or wrap applicator 51. The wrap guide/wrap applicator 51 is configured to move (e.g., rotate) to direct the bale wrap 49 into contact with the bale 39. The bale wrap 49 is captured between the bale 39 and the belt(s) 37. Accordingly, rotation of the bale 39 draws the bale wrap 49 around the bale 39, thereby wrapping the bale 39.

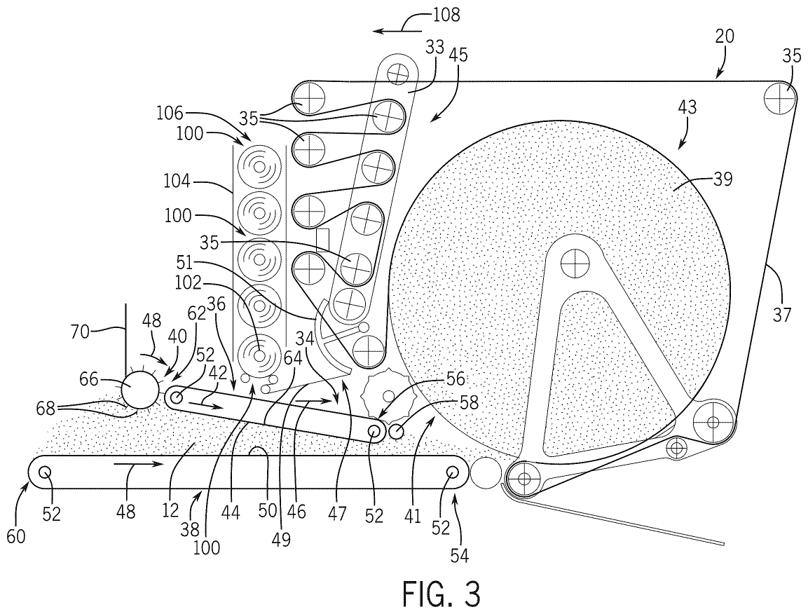

FIG. 3 is a schematic view of an embodiment of a conveying system 34 that may be employed within the agricultural product transport assembly of FIG. 2. As previously discussed, the first belt 36 is configured to rotate in a first rotational direction 42 to move an agricultural product engaging surface 44 of the first belt 36 toward the cavity 41 (e.g., bale formation cavity) of the baler 20 along a translational direction 46. Furthermore, the second belt 38 is positioned on an opposite side of the agricultural product 12 from the first belt 36, and the second belt 38 is configured to rotate in a second rotational direction 48, opposite the first rotational direction 42 to move an agricultural product engaging surface 50 of the second belt 38 toward the cavity 41 along the translational direction. Accordingly, the first belt 36 and the second belt 38 are configured to cooperate to move the agricultural product 12 from the accumulator 26 to the cavity 41 along the translational direction 46. In the illustrated embodiment, the first belt 36 and the second belt 38 (e.g., the agricultural product engaging surface 44 of the first belt 36 and the agricultural product engaging surface 50 of the second belt 38) converge along the translational direction 46 toward the cavity 41, thereby compressing the agricultural product 12 between the agricultural product engaging surfaces of the belts.

In the illustrated embodiment, each belt extends along an entire lateral extent of the conveying system (e.g., extent of the conveying system crosswise to the translational direction). However, in other embodiments, the conveying system may include multiple first belts distributed along the lateral extent of the conveying system, and/or the conveying system may include multiple second belts distributed along the lateral extent of the conveying system. Furthermore, in the illustrated embodiment, each belt is rotatably supported by two rollers 52, in which the rollers 52 are positioned at opposite ends of the belt with respect to the translational direction 46, and the rollers 52 extend along the entire lateral extent of the conveying system. However, in other embodiments, at least one belt may be supported by one or more additional rollers. For example, at least one belt may be supported by at least one additional roller positioned along the length of the belt with respect to the translational direction, and/or at least one belt may be supported by at least one additional roller positioned along a lateral extent of the belt (e.g., multiple rollers may be distributed along the lateral extent of the belt at a common position along the length of the belt with respect to the translational direction). In addition, while the belts converge along the translational direction 46 toward the cavity 41 in the illustrated embodiment, in other embodiments, the belts (e.g., the agricultural product engaging surfaces of the belts) may diverge or be parallel to one another along the translational direction 46 toward the cavity 41. Furthermore, while the conveying system 34 includes belts positioned on opposite sides of the agricultural product 12 in the illustrated embodiment, in other embodiments, the conveying system may only include belt(s) positioned on one side of the agricultural product. For example, in certain embodiments, the conveying system may include belt(s) positioned on one side of the agricultural product and a bearing surface positioned on the opposite side of the agricultural product.

In the illustrated embodiment, the length of the second belt 38 with respect to the translational direction 46 is greater than the length of the first belt 36 with respect to the translational direction 46. As illustrated, a downstream end 54 of the second belt 38 extends beyond a downstream end 56 of the first belt 36 with respect to the translational direction 46. In the illustrated embodiment, a blocking roller 58 is positioned at the downstream end 56 of the first belt 36 on the opposite side of the agricultural product 12 from the second belt 38. The blocking roller 58 is configured to block movement of the agricultural product 12 to a region above the first belt 36. While the downstream end 54 of the second belt 38 extends beyond the downstream end 56 of the first belt 36 with respect to the translational direction 46 in the illustrated embodiment, in other embodiments, the downstream end of the first belt may extend beyond the downstream end of the second belt with respect to the translational direction, or the downstream ends of the belts may be located at the same position with respect to the translational direction. Furthermore, in certain embodiments, the blocking roller may be omitted.

In the illustrated embodiment, an upstream end 60 of the second belt 38 is positioned upstream of an upstream end 62 of the first belt 36 with respect to the translational direction 46. As illustrated, the leveling drum assembly 40 is positioned proximate to the upstream end 62 of the first belt 36, and the leveling drum assembly 40 is positioned on the opposite side of the agricultural product 12 from the second belt 38. While the upstream end 60 of the second belt 38 is positioned upstream of the upstream end 62 of the first belt 36 with respect to the translational direction 46 in the illustrated embodiment, in other embodiments, the upstream end of the first belt may be positioned upstream of the upstream end of the second belt with respect to the translational direction, or the upstream ends of the belts may be located at the same position with respect to the translational direction. Furthermore, in certain embodiments, the length of the first belt may be equal to or greater than the length of the second belt. In addition, in the illustrated embodiment, the upstream end 60 of the second belt 38 is positioned upstream of the leveling drum assembly 40 with respect to the translational direction 46, such that the leveling drum assembly 40 overlaps the second belt 38 with respect to the translational direction 46. However, in other embodiments, the upstream end of the second belt may be positioned downstream from the leveling drum assembly with respect to the translational direction, or the upstream end of the second belt and the leveling drum assembly may be located at the same position with respect to the translational direction.

In the illustrated embodiment, the first belt 36 and the leveling drum assembly 40 are positioned above the agricultural product 12, and the second belt 38 is positioned below the agricultural product 12. In addition, the leveling drum assembly 40 is positioned upstream of the first belt 36, which is configured to move the agricultural product 12 from the accumulator to the bale formation cavity of the baler. The leveling drum assembly 40 is configured to rotate in the second rotational direction 48, which is opposite the first rotational direction 42 of the first belt 36. In addition, as previously discussed, the leveling drum assembly 40 is configured to level a surface 64 of the agricultural product 12 before the surface 64 of the agricultural product 12 engages the agricultural product engaging surface 44 of the first belt 36. In the illustrated embodiment, the leveling drum assembly 40 includes a drum 66 configured to rotate about a first axis of rotation in the second rotational direction 48. The leveling drum assembly 40 also includes multiple tines 68 configured to extend through respective apertures in the drum 66. Furthermore, as discussed in detail below, the leveling drum assembly 40 includes an actuation mechanism configured to drive a portion of the tines 68 to extend through the respective apertures as the portion of the tines approaches the agricultural product 12 and to drive the portion of the tines to retract as the portion of the tines moves away from the agricultural product. For example, in certain embodiments, the actuation mechanism includes a shaft disposed within the drum and configured to rotate about a second axis of rotation offset from the first axis of rotation, in which the tines are pivotally coupled to the shaft.

In the illustrated embodiment, the conveying system 34 includes a shield 70 positioned adjacent to the leveling drum assembly 40 and configured to block flow of the agricultural product 12 around the leveling drum assembly 40 along the second rotational direction 48. The spacing between the drum 66 and the shield 70 may be selected to substantially block movement of the agricultural product 12 through the interface between the shield and the drum 66 in the second rotational direction 48 as the leveling drum assembly 40 rotates in the second rotational direction 48. The actuation mechanism is configured to drive a portion of the tines to extend through the respective apertures after the portion of the tines passes the shield along the second rotational direction and as the portion of the tines approaches the agricultural product. In addition, the actuation mechanism is configured to drive the portion of the tines to retract as the portion of the tines moves away from the agricultural product along the second rotational direction and before the portion of the tines reaches the shield. Accordingly, the tines may engage the agricultural product while extended. In addition, due to the retraction of the tines, the shield may be placed sufficiently close to the drum to substantially block movement of the agricultural product around the leveling drum assembly along the second rotational direction. As previously discussed, the combination of the drum 66 and the tines 68 is configured to level the surface 64 of the agricultural product 12, thereby enhancing the uniformity of the distribution of the agricultural product 12 entering the cavity 41 of the baler 20. As a result, density variations within the resultant bale may be reduced, thereby enhancing downstream processing of the agricultural product.

In the illustrated embodiment, the leveling drum assembly 40 extends along the entire lateral extent of the conveying system (e.g., extent of the conveying system crosswise to the translational direction 46). However, in other embodiments, the conveying system may include multiple drum assemblies distributed along the lateral extent of the conveying system. In such embodiments, each leveling drum assembly may include any of the features and variations disclosed herein. Furthermore, in the illustrated embodiment, the shield 70 extends along the entire lateral extent of the conveying system (e.g., extent of the conveying system crosswise to the translational direction 46). However, in other embodiments, the conveying system may include multiple shields distributed along the lateral extent of the conveying system, such that the shields collectively block flow of the agricultural product around the leveling drum assembly/assemblies along the second rotational direction. In addition, in certain embodiments, the leveling drum assembly/assemblies may have tines fixed to the drum (e.g., the actuation mechanism configured to drive the tines to move may be omitted). In such embodiments, the shield(s) may be omitted, or the shield(s) may be spaced apart from the drum by a sufficient distance to provide clearance between the fixed tines and the shield(s).

As previously discussed, the bale wrapping system 47 is configured to wrap the bale 39 with a bale wrap 49 to secure the agricultural product within the bale 39 and to generally maintain the shape of the bale. The bale wrap 49 is provided by one bale wrap roll 100 of a set of bale wrap rolls. In the illustrated embodiment, each bale wrap roll 100 of the set includes a shaft 102, and the bale wrap 49 is wrapped around the shaft 102 to form the bale wrap roll 100. However, in other embodiments, the shaft may be omitted from at least one bale wrap roll, and the bale wrap may be arranged in a rolled configuration (e.g., with a hollow region at the center). As the bale wrap 49 is fed toward the bale 39, the respective bale wrap roll 100 rotates (e.g., about the shaft 102), thereby providing the bale wrap to the bale.

In the illustrated embodiment, the set of bale wrap rolls 100 is stored within a hopper 104 of the baler 20. In the illustrated embodiment, the hopper 104 is configured to store five bale wrap rolls 100 (e.g., the hopper 104 has a capacity of five bale wrap rolls 100). However, in other embodiments, the hopper 104 may be configured to store more or fewer bale wrap rolls (e.g., 2, 3, 4, 6, 7, 8, or more). Furthermore, in the illustrated embodiment, the hopper 104 is configured to store the bale wrap rolls 100 in a vertical arrangement. However, in other embodiments, the hopper may be configured to store the bale wrap rolls in another suitable arrangement (e.g., angled with respect to a vertical axis of the baler, etc.). In addition, in the illustrated embodiment, the hopper 104 is configured to store the bale wrap rolls 100 in a single stack. However, in other embodiments, the hopper may be configured to store the bale wrap rolls in multiple stacks (e.g., 2, 3, 4, etc.), in which the stacks converge to an outlet that is configured to present a single bale wrap roll to the bale wrapping system 47.

The bale wrapping system 47 is configured to use the bale wrap 49 from the bottom bale wrap roll 100 for wrapping the bale 39. For example, while a bale wrap roll 100 is in a bottom position, the feed rollers of the bale wrapping system 47 may direct the bale wrap 49 of the bottom bale wrap roll 100 over the wrap guide or wrap applicator 51 of the bale wrapping system 47. As previously discussed, the wrap guide or wrap applicator 51 is configured to move (e.g., rotate) to direct the bale wrap 49 into contact with the bale 39. In response to depletion of the bale wrap of the bottom bale wrap roll, the next bale wrap roll (e.g., the bale wrap roll directly above the bottom bale wrap roll) may shift downwardly in the hopper 104, and the bale wrapping assembly 47 may direct the bale wrap 49 of the bottom bale wrap roll 100 over the wrap guide or wrap applicator 51. In certain embodiments, the shaft of the depleted bale wrap roll may be removed before the next bale wrap roll shifts downwardly.

Furthermore, in certain embodiments, each bale wrap roll 100 may be loaded into the hopper 104 via an inlet 106 at a top of the hopper 104. Accordingly, the bale wraps of the bale wrap rolls may be used in the order the bale wrap rolls are loaded into the hopper, thereby reducing the duration each bale wrap roll remains within the hopper (e.g., as compared to a configuration in which each bale wrap roll is loaded into the hopper via an inlet at the bottom, which may cause the bale wrap rolls at the top to remain unused as additional bale wrap rolls are loaded from the bottom). However, in other embodiments, the hopper may include an inlet at the bottom of the hopper and/or at any other suitable location on the hopper.

In the illustrated embodiment, the hopper 104 is positioned forward of the cavity 41 (e.g., bale formation cavity) relative to a forward direction of travel 108 of the agricultural machine system. As illustrated, the hopper 104 is also positioned forward of the tension arm 33, the rollers 35, and the wrap guide or wrap applicator 51 relative to the forward direction of travel 108. Furthermore, in the illustrated embodiment, the hopper 104 is positioned rearward of the accumulator relative to the forward direction of travel 108. Accordingly, the hopper 104 is positioned between the accumulator and the cavity 41 with respect to a longitudinal axis of the agricultural machine system (e.g., which extends parallel to the forward direction of travel). However, in other embodiments, the hopper may be positioned at another suitable location within the agricultural machine system, such as forward of the accumulator with respect to the forward direction of travel, rearward of the cavity with respect to the forward direction of travel, or at another suitable location within the agricultural machine system. Furthermore, in the illustrated embodiment, the hopper 104 is generally laterally aligned with the cavity 41 (e.g., with respect to a lateral axis perpendicular to the longitudinal axis) to enable the bale wrap 49 to be fed from the bottom bale wrap roll 100 to the bale 39.

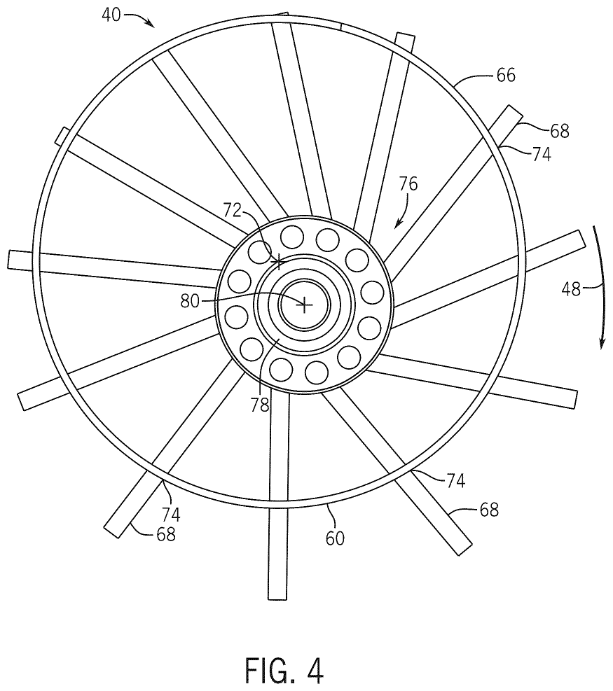

FIG. 4 is a cross-sectional view of an embodiment of a leveling drum assembly 40 that may be employed within the conveying system of FIG. 3. In the illustrated embodiment, the drum 66 is configured to rotate about a first axis of rotation 72 in the second rotational direction 48. Furthermore, as previously discussed, the tines 68 are configured to extend through apertures 74 in the drum 66. In addition, the leveling drum assembly 40 includes an actuation mechanism 76 configured to drive a portion of the tines 68 to extend through the respective apertures 74 as the portion of the tines approaches the agricultural product, and the actuation mechanism 76 is configured to drive the portion of the tines 68 to retract as the portion of the tines moves away from the agricultural product. In the illustrated embodiment, the actuation mechanism 76 includes a shaft 78 disposed within the drum 66 and configured to rotate about a second axis of rotation 80 offset from the first axis of rotation 72. As illustrated, the tines 68 are pivotally coupled to the shaft 78. Accordingly, as the leveling drum assembly 40 rotates in the second rotational direction 48, the offset between the axes of rotation causes the tines 68 to extend and retract. The second axis of rotation 80 is offset from the first axis of rotation 72 to drive a portion of the tines 68 to extend as the portion of the tines 68 approaches the agricultural product in response to rotation of the leveling drum assembly 40 in the second rotational direction 48. Accordingly, the tines 68 may engage the agricultural product. In addition, the offset between the axes causes the portion of the tines 68 to retract as the portion of the tines 68 moves away from the agricultural product and before the portion of the tines 68 reach the shield. Accordingly, the shield may be placed sufficiently close to the drum to substantially block movement of the agricultural product around the leveling drum assembly along the second rotational direction.

In certain embodiments, the shaft 78 may be rotatably coupled to a chassis/frame of the agricultural machine system by any suitable type of connection(s) (e.g., including bearing(s), bushing(s), axle(s), etc.), thereby enabling the shaft 78 to rotate about the second axis of rotation 80. Furthermore, the drum 66 may be rotatably coupled to the chassis/frame of the agricultural machine system by any suitable type(s) of connection(s) (e.g., including bearing(s), roller(s), etc.). For example, rollers (e.g., positioned inside and/or outside of the drum) rotatably coupled to the chassis/frame may support the drum and enable the drum to rotate about the first axis of rotation 80. Furthermore, the leveling drum assembly 40 may be driven to rotate by any suitable drive(s), such as hydraulic motor(s), electric motor(s), pneumatic motor(s), other suitable drive(s), or a combination thereof. For example, in certain embodiments, the shaft may be driven to rotate, and the shaft may drive the drum to rotate (e.g., via gear(s)), such that the drum rotates with the shaft. Furthermore, in certain embodiments, the drum may be driven to rotate, and the drum may drive the shaft to rotate (e.g., via gear(s)), such that the shaft rotates with the drum. In addition, in certain embodiments, the shaft and the drum may be independently driven to rotate by separate drives, in which the drives are controlled, such that the drum and the shaft rotate together.

In certain embodiments, the offset of the second axis of rotation 80 relative to the first axis of rotation 72 may be selected, such that the portion of the tines reaches a maximum extension while a respective portion of the drum (e.g., the portion of the drum having the apertures through which the portion of the tines extends) is tangent to the surface of the agricultural product. For example, in embodiments in which the drum is positioned above the agricultural product, the portion of the tines may reach the maximum extension while the portion of the tines is positioned at the bottom of the leveling drum assembly. However, in certain embodiments, the offset of the second axis of rotation relative to the first axis of rotation may be selected, such that the portion of the tines reaches the maximum extension while a different portion of the drum is tangent to the surface of the agricultural product. Furthermore, in certain embodiments, the shaft 78 is oriented relative to the drum along the second rotational direction 48 to angle each of the tines with the greatest extension substantially perpendicularly to the surface of the agricultural product. For example, in embodiments in which the drum is positioned above the agricultural product, the tines with the greatest extension may extend downwardly from the shaft. However, in certain embodiments, the shaft may be oriented relative to the drum along the second rotational direction to angle the tines with the greatest extension at another suitable orientation relative to the surface of the agricultural product.

In the illustrated embodiment, each tine 68 has a circular cross-sectional shape. However, in other embodiments, at least one tine may have another suitable cross-sectional shape (e.g., elliptical, polygonal, irregular, etc.). Furthermore, in the illustrated embodiment, each tine is straight (e.g., extending linearly from a proximal end to a distal end of the tine). However, in other embodiments, at least one tine may have another suitable shape (e.g., curved, a combination of curved and straight sections, etc.). The tines 68 may be distributed along the first axis of rotation 72 of the drum 66 (e.g., along the lateral extent of the conveying system). For example, as discussed in detail below, the tines 68 and the respective apertures 74 may be arranged in any suitable pattern, such as a helical pattern, a single chevron pattern, a multiple chevron patter, or another suitable pattern.

While the second axis of rotation 80 is offset from the first axis of rotation 72 to drive a portion of the tines 68 to extend as the portion of the tines approaches the agricultural product and to drive the portion of the tines 68 to retract as the portion of the tines moves away from the agricultural product in response to rotation of the leveling drum assembly 40 in the illustrated embodiment, in other embodiments, the second axis of rotation may be offset from the first axis of rotation to drive a portion of the tines to extend as the portion of the tines approaches/moves away from another target and/or to drive the portion of the tines to retract as the portion of the tines approaches/moves away from another target in response to rotation of the leveling drum assembly. Furthermore, while the actuation mechanism 76 includes the shaft 78 in the illustrated embodiment, in other embodiments, the actuation mechanism may include other suitable actuation device(s) (e.g., actuator(s), crank assembly/assemblies, cam and follower assembly/assemblies, etc.). For example, in certain embodiments, the actuation mechanism may include actuators (e.g., hydraulic cylinder(s), electric linear actuator(s), pneumatic cylinder(s), electric motor(s), etc.) configured to drive individual tine(s) and/or group(s) of the tines to extend and retract as the leveling drum assembly rotates. In addition, while the leveling drum assembly 40 is configured to rotate in the second rotational direction 48 in the embodiments disclosed herein, in certain embodiments, the leveling drum assembly may be configured to rotate in the first rotational direction.

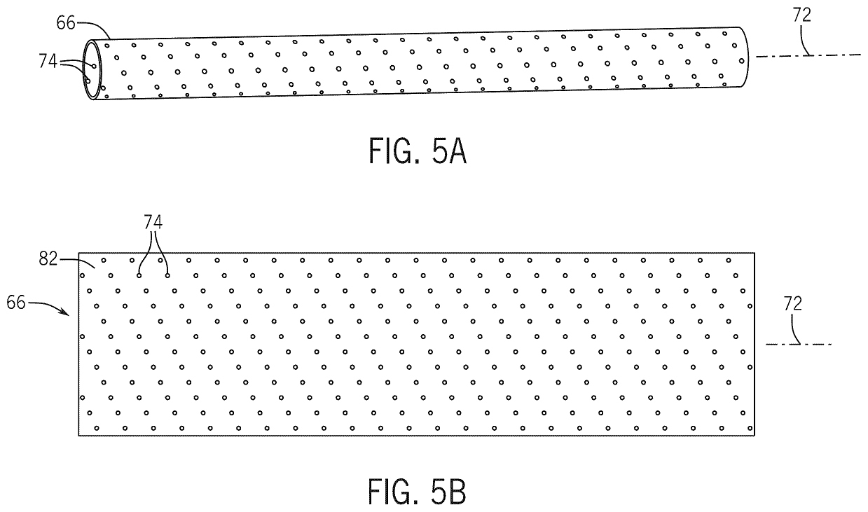

FIG. 5A is a perspective view of an embodiment of a drum 66 that may be employed within the leveling drum assembly of FIG. 4, and FIG. 5B is a projection view of an outer surface 82 of the drum 66 of FIG. 5A. In the illustrated embodiment, the apertures 74 of the drum 66 and the respective tines are arranged in a helical pattern. The helical pattern of the tines may enable the tines to move the agricultural product laterally across the conveying system as the leveling drum assembly rotates, thereby enhancing the uniformity of the distribution of the agricultural product along the lateral extent of the conveying system.

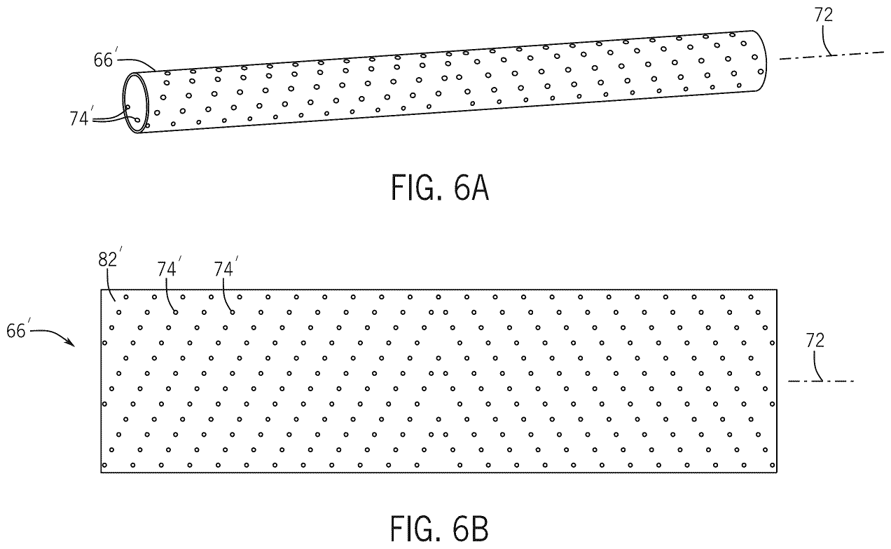

FIG. 6A is a perspective view of another embodiment of a drum 66′ that may be employed within the leveling drum assembly of FIG. 4, and FIG. 6B is a projection view of an outer surface 82′ of the drum 66′ of FIG. 6A. In the illustrated embodiment, the apertures 74′ of the drum 66′ and the respective tines are arranged in a single chevron pattern. The single chevron pattern of the tines may enable the tines to move the agricultural product laterally outwardly across the conveying system as the leveling drum assembly rotates, thereby enhancing the uniformity of the distribution of the agricultural product along the lateral extent of the conveying system.

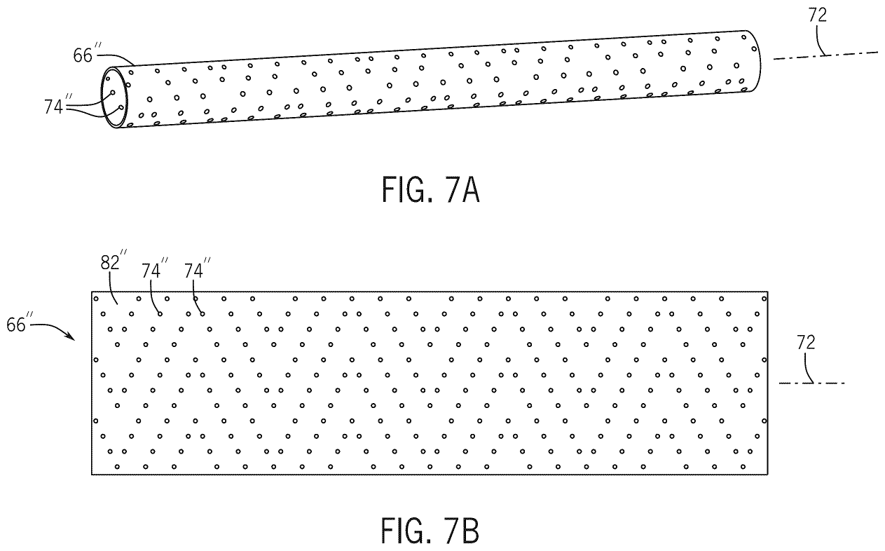

FIG. 7A is a perspective view of a further embodiment of a drum 66″ that may be employed within the leveling drum assembly of FIG. 4, and FIG. 7B is a projection view of an outer surface 82″ of the drum 66″ of FIG. 7A. In the illustrated embodiment, the apertures 74″ of the drum 66″ and the respective tines are arranged in a multiple chevron pattern. In the illustrated embodiment, the apertures/tines are arranged in a three chevron pattern. However, in other embodiments, the apertures/tines may be arranged in a two chevron pattern, a four chevron pattern, or another suitable chevron pattern. The multiple chevron pattern of the tines may enable the tines to move the agricultural product laterally outwardly across the conveying system as the leveling drum assembly rotates, thereby enhancing the uniformity of the distribution of the agricultural product along the lateral extent of the conveying system. While apertures/tines arranged in a helical pattern, a single chevron pattern, and a multiple chevron pattern are disclosed above, in certain embodiments, the apertures/tines may be arranged in another suitable pattern (e.g., in straight rows and columns, in an irregular/random pattern, etc.).

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

1. A baler for an agricultural machine system, comprising:
a hopper configured to store a plurality of bale wrap rolls, wherein the hopper is configured to be positioned forward of a bale formation cavity relative to a forward direction of travel of the agricultural machine system, and the bale formation cavity is configured to receive agricultural product to facilitate formation of a bale; and
a bale wrapping system configured to receive a bale wrap from a bottom bale wrap roll of the plurality of bale wrap rolls and to direct the bale wrap toward the bale.

2. The baler of claim 1, wherein the hopper is configured to store the plurality of bale wrap rolls in a vertical arrangement.

3. The baler of claim 1, wherein the hopper is configured to be positioned between the bale formation cavity and an accumulator of the agricultural machine system with respect to a longitudinal axis of the agricultural machine system.

4. The baler of claim 1, wherein the hopper comprises an inlet configured to receive each bale wrap roll of the plurality of bale wrap rolls, and the inlet is positioned at a top of the hopper.

5. The baler of claim 1, wherein the hopper has a capacity of five bale wrap rolls.

6. A conveying system for an agricultural harvester, comprising:
a leveling drum assembly configured to be positioned upstream of a belt configured to move agricultural product from an accumulator to a bale formation cavity of a baler, wherein the leveling drum assembly is configured to rotate in an opposite direction relative to a direction of rotation of the belt, the leveling drum assembly is configured to level a surface of the agricultural product before the surface of the agricultural product engages the belt, and the leveling drum assembly comprises:
a drum configured to rotate about a first axis of rotation;
a shaft disposed within the drum and configured to rotate about a second axis of rotation offset from the first axis of rotation; and
a plurality of tines pivotally coupled to the shaft and configured to extend through respective apertures in the drum.

7. The conveying system of claim 6, wherein the second axis of rotation is offset relative to the first axis of rotation to drive a portion of the plurality of tines to extend as the portion of the plurality of tines approaches the agricultural product in response to rotation of the leveling drum assembly.

8. The conveying system of claim 6, wherein the shaft is oriented to angle each tine of the plurality of tines with the greatest extension substantially perpendicularly to the surface of the agricultural product.

9. The conveying system of claim 6, wherein the plurality of tines and the respective apertures of the drum are arranged in a helical pattern.

10. The conveying system of claim 6, wherein the plurality of tines and the respective apertures of the drum are arranged in a single chevron pattern.

11. The conveying system of claim 6, wherein the plurality of tines and the respective apertures of the drum are arranged in a multiple chevron pattern.

12. The conveying system of claim 6, wherein each tine of the plurality of tines has a circular cross-sectional shape.

13. The conveying system of claim 6, comprising the belt and a second belt, wherein the second belt is configured to be positioned on an opposite side of the agricultural product from the belt and the leveling drum assembly, the second belt is configured to cooperate with the belt to move the agricultural product from the accumulator to the bale formation cavity, and the belt and the second belt converge along a translational direction toward the bale formation cavity to compress the agricultural product.

14. A conveying system for an agricultural harvester, comprising:
a leveling drum assembly configured to be positioned upstream of a belt configured to move agricultural product from an accumulator to a bale formation cavity of a baler, wherein the leveling drum assembly is configured to rotate in an opposite direction relative to a direction of rotation of the belt, the leveling drum assembly is configured to level a surface of the agricultural product before the surface of the agricultural product engages the belt, and the leveling drum assembly comprises:
a drum configured to rotate;
a plurality of tines configured to extend through respective apertures in the drum; and
an actuation mechanism configured to drive a portion of the plurality of tines to extend through the respective apertures as the portion of the plurality of tines approaches the agricultural product and to drive the portion of the plurality of tines to retract as the portion of the plurality of tines moves away from the agricultural product.

15. The conveying system of claim 14, wherein the actuation mechanism is configured to angle each tine of the plurality of tines with the greatest extension substantially perpendicularly to the surface of the agricultural product.

16. The conveying system of claim 14, wherein the plurality of tines and the respective apertures of the drum are arranged in a helical pattern.

17. The conveying system of claim 14, wherein the plurality of tines and the respective apertures of the drum are arranged in a single chevron pattern.

18. The conveying system of claim 14, wherein the plurality of tines and the respective apertures of the drum are arranged in a multiple chevron pattern.

19. The conveying system of claim 14, wherein each tine of the plurality of tines has a circular cross-sectional shape.

20. The conveying system of claim 14, comprising the belt and a second belt, wherein the second belt is configured to be positioned on an opposite side of the agricultural product from the belt and the leveling drum assembly, the second belt is configured to cooperate with the belt to move the agricultural product from the accumulator to the bale formation cavity, and the belt and the second belt converge along a translational direction toward the bale formation cavity to compress the agricultural product.
